(19) United States
(12) Patent Application Publication
(10) Pub. No.: US 2026/0113690 A1
(43) Pub. Date: Apr. 23, 2026

(54) ACCESSBILITY MANAGEMENT OF A USER EQUIPMENT TO A ROAMING NETWORK

(71) Applicant: T-MOBILE INNOVATIONS LLC, Overland Park, KS (US)

(72) Inventor: Ariful Islam KAZI, Renton, WA (US)

(21) Appl. No.: 18/924,549

(22) Filed: Oct. 23, 2024

(51) Int. Cl. H04W 48/04; H04W 8/02

(52) U.S. Cl. CPC H04W 48/04; H04W 8/02

(57) ABSTRACT

Embodiments of the present disclosure are directed to systems and methods for managing network accessibility of a user equipment (UE) in a communications network. For example, a user equipment's (UE) compatibility for accessing a roaming network may be determined by analyzing device information of the UE and one or more features of the roaming network. A roaming subscription information (RSI) list associated with the UE may be modified based on the analysis in order to appropriately manage the accessibility of the UE to the roaming network.

### SUMMARY

The present disclosure is directed, in part, to managing network accessibility of a user equipment (UE) to a roaming network in a communications network, substantially as shown and/or described in connection with at least one of the figures, and as set forth more completely in the claims.

According to various aspects of the technology, roaming networks may enable subscribers of one communications network operator to use mobile services (e.g., voice calls, text messaging, and data access) when they are outside their home network's coverage area. Roaming networks that have a roaming agreement with the home network that may allow a user equipment (UE) to latch onto the roaming network. Operators may use roaming networks to maintain customer satisfaction, generate additional revenue streams from roaming charges, and uphold service continuity.

Some jurisdictional requirements include mandates requiring that all UEs are able to make emergency calls (e.g., 911 in the United States) when they are outside the coverage of their home network; however, this requirement can lead to challenges in certain situations, for example, when dealing with gray-market devices (e.g., uncertified UEs imported through unofficial channels) or UEs that are not fully compliant with the home network's standards. Such UEs may come with their own IP Multimedia Subsystem (IMS) stack, which helps in handling IP-based services like Voice over LTE (VoLTE) and emergency calling. Unlike officially supported UEs, non-compliant UEs might have a customized IMS stack that is not recognized by the home network operator, which may cause the operator to be unable to push firmware updates. This may create a problem when the non-compliant UEs roam into a network that requires specific IMS configurations for emergency calling, such as particular VoLTE profiles or supported Session Initiation Protocol (SIP) signaling features. Without the ability to update the UE or ensure that it conforms to the network's emergency call standards, both the home and visited networks could face issues complying with these jurisdictional mandates.

To address the challenges posed by non-compliant UEs, a controller, whether integrated within a Roaming Steering Server (RSS) or functioning as a separate component, may manage interactions between one or more of the RSS, an Equipment Identity Register (EIR), and a Unified Network Directory Server (UNDS). For example, the controller may query the EIR for device information such as an International Mobile Equipment Identity and Software Version (IMEISV) of the UE. For gray-listed UEs, as determined from the IMEIV, the controller may retrieve Roaming Steering Information (RSI) from a Unified Network Directory Server (UNDS). By analyzing this information, the controller may determine whether a roaming network is compatible with the UE's current IMS stack or if adjustments are necessary to help ensure compliance for emergency services. If the UE's software version or IMS stack is incompatible with the roaming network, the RSI associated with the UE may be modified to restrict access to the roaming network. Conversely, if the UE's software version or IMS stack is compatible with the roaming network, the RSI associated with the UE may be modified to allow access to the roaming network. Accordingly, the present solution involves systems and methods for managing network accessibility of a UE in a communications network to help ensure compliance with jurisdictional mandates.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed;

FIG. 4 illustrates a flow chart of an exemplary method for managing network accessibility of a user equipment (UE) in a communications network in which implementations of the present disclosure may be employed; and

FIG. 5 illustrates a flow chart of another exemplary method for managing network accessibility of a user equipment (UE) in a communications network in which implementations of the present disclosure may be employed.

### DETAILED DESCRIPTION

By way of background, when a UE attempts to access a roaming network, the process may be governed by interactions between multiple network components that help ensure the device can connect to the roaming network while adhering to the home network's policies and jurisdictional requirements. When the UE moves outside its home network's coverage area, it may begin scanning for available networks that have roaming agreements with the home operator. The RSS, along with data from the UNDS (e.g., RSI), may direct the UE toward a preferred network based on various factors. However, not all UEs are fully compatible with every roaming network, especially in cases where jurisdictional or network-specific requirements differ from those of the home network. For example, different countries may have specific regulation regarding emergency calls (e.g., the FCC in the United States), which may include mandates that all UEs must be capable of making emergency calls, even when roaming. In some cases, a UE may be incompatible with the roaming network due to such things as differences in software versions, network technology (e.g., LTE versus 3G), and/or support for specific services like VoLTE, which is often required for emergency calling.

One of the challenges arises with gray-market devices or UEs that are imported through unofficial channels and may not be fully supported by the home network. These UEs might have proprietary or outdated IMS stacks, which play a role in handling services like VoLTE or emergency calls. If a UE's IMS stack is incompatible with the roaming network's configuration (e.g., one or more features of the roaming network), the UE may be unable to register for VoLTE, resulting in a lack of support for emergency calling. In some cases, even when the home network can authenticate the device, the roaming network may block access to essential services due to the UE's failure to meet local network of regulatory standards.

To address the challenges posed by such non-compliant UEs, particularly in ensuring the ability to make emergency calls in a roaming network, a solution can be implemented using a controller integrated into or working alongside the RSS. This controller may manage the interaction between the RSS, EIR, and UNDS to dynamically adjust roaming policies based on the UE's capabilities and network compatibility.

For example, the controller may receive an indication to initiate a logic flow, which could be triggered by a UE's attempt to register on a roaming network, a UE's attempt to register on a home network, and/or a periodic network or device check. The indication may also be derived from identifying that a UE is on a gray list stored in the EIR, which may indicate that the device is operating with an outdated software version or lacks compliance with certain network requirements. Once triggered, the controller may coordinate with the RSS to retrieve the IMEISV from the EIR and the associated RSI from the UNDS.

After retrieving the device information (e.g., IMEISV), the control may initiate an analysis of the IMEISV to assess the compatibility of the UE with the roaming network. This analysis may include identifying whether the UE's software version is up-to-date and compatible with the protocols used by the roaming network, such as VoLTE or SIP features required for emergency call handling. The controller may also consider one or more features of the roaming network such as supported network technologies (e.g., the availability of 4G/5G or fallback to 3G/2G for emergency calls), network capabilities (e.g., support for emergency call routing and compliance with jurisdictional regulation like the FCC's mandate for emergency call access), and/or performance metrics (e.g., real-time network quality metrics like latency, congestion, and signal strength, which might impact emergency call reliability). The controller may evaluate the compatibility of the UE with such network features. If the UE's software version, as indicated by the IMEISV, supports the network's emergency call protocols, the UE may be considered compatible. Conversely, if the UE's outdated or proprietary software version does not support for the necessary protocols (e.g., lacking VoLTE support), the controller may flag the UE as incompatible with the roaming network.

Based on the determination of compatibility or incompatibility, the RSI associated with the UE may be modified accordingly. For example, if the UE is determined to be compatible, the RSI may be modified to authorize the roaming network, allowing the UE to access the roaming network and utilize essential services, including emergency calling. The RSS may then communicate this modified RSI to the network elements, permitting the UE to register and operate within the roaming network. However, if the UE is determined to be incompatible with the roaming network due to its inability to, for example, make an emergency call, the controller may modify the RSI to restrict access to the network. This restriction may involve steering the UE away from the incompatible network to another network that provides fallback emergency services (e.g., such as a network that support legacy technologies). Alternatively, the controller may implement a limited registration, restricting the UE's access to certain services while ensuring it can still make emergency calls, if possible. In other words, by analyzing the IMESIV and the features of available roaming networks, the controller may adjust RSI to either authorize or restrict network access based on the UE's ability to comply with local regulations and network requirements. This system helps provide a flexible and robust approach to maintaining service continuity and regulatory compliance, even for UEs with software limitations or gray-market origins.

In one non-limiting example scenario, a gray-market device has an outdated IMS stack, preventing it from utilizing VoLTE. When this UE attempts to register on a 4G-only roaming network, the controller identifies the device on the gray list via the EIR and retrieves the IMEISV. After analyzing the IMEISV, the controller determines that the device's software is incompatible with the 4G network's emergency call requirements. As a result, the controller modifies the RSI to restrict the device from accessing the 4G roaming network and steers it toward an alternative network that still supports 3G, allowing the UE to make emergency calls even though it cannot use 4G services.

Accordingly, a first aspect of the present disclosure is directed to a system for managing network accessibility of a user equipment (UE) in a communications network. The system includes a network device comprising one or more processors. The system further includes a non-transitory computer-readable media configured to receive, at the network device, an indication to initiate a logic flow. The computer-readable media is further configured to retrieve, by the network device during the logic flow, device information and roaming subscription information (RSI) associated with the UE. The computer-readable media is further configured to, based on the device information and one or more features of a roaming network, determine an incompatibility between the UE and the roaming network. The computer-readable media is further configured to modify, based on the determination, the RSI associated with the UE to create a modified RSI, wherein the modified RSI comprises a restriction of the roaming network, and wherein the restriction prevents the UE from accessing the roaming network.

A second aspect of the present disclosure is directed to a system for managing network accessibility of a user equipment (UE) in a communications network. The system includes a network device comprising one or more processors. The system further includes a non-transitory computer-readable media configured to receive, at the network device, an indication to initiate a logic flow. The computer-readable media is further configured to retrieve, by the network device during the logic flow, device information and roaming subscription information (RSI) associated with the UE. The computer-readable media is further configured to, based on the device information and one or more features of a roaming network, determine a compatibility between the UE and the roaming network. The computer-readable media is further configured to modify, based on the determination, the RSI associated with the UE to create a modified RSI, wherein the modified RSI comprises an authorization of the roaming network, and wherein the authorization allows the UE to access the roaming network.

A third aspect of the present disclosure is directed to a method for managing network accessibility of a user equipment (UE) in a communications network. The method includes receiving an indication to initiate a logic flow. The method further includes retrieving device information and roaming subscription information (RSI) associated with the UE. The method further includes, based on the device information and one or more features of a roaming network, determining an incompatibility between the UE and the roaming network. The method further includes modifying, based on the determination, the RSI associated with the UE to create a modified RSI, wherein the modified RSI comprises a restriction of the roaming network, and wherein the restriction prevents the UE from accessing the roaming network.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, a “roaming network” may refer to any communications network that provides connectivity and communication services to a UE when the UE is outside the coverage area of its home network. A roaming network may allow subscribers to maintain access to services such as voice calls, text messaging, data access, and emergency calls when they are geographically located outside their home operator's direct network footprint. A roaming network may be operated by a different service provider than the home network, with which it may establish roaming agreements to help enable seamless connectivity. Roaming networks may support various technical and regulatory requirements to ensure interoperability, billing, and service continuity, regardless of differences in infrastructure, technology standards, or local regulations across different regions or countries.

As used herein, a “Roaming Steering Server (RSS)” may refer to a component in a communications network that helps manage and optimize the process of steering roaming traffic across various partner networks. For example, a RSS may help ensure that roaming subscriber UEs are connected to the most suitable networks when outside their home network's coverage area, for example, based on predefined policies, real-time conditions, and/or business agreements between operators. The RSS may interact with several core network components, such as a UNDS and Policy and Charging Rules Function (PCRF), to enforce network preferences stored in RSI lists.

As used herein, a “Unified Network Directory Server (UNDS)” may refer to a centralized repository that helps with managing network preferences, subscriber policies, and/or roaming-related data. For example, the UNDS may maintain the “RSI,” which may refer to a set of data and policies used to steer a UE to suitable roaming networks when subscribers travel outside their home network's coverage area. The RSI stored in the UNDS may contain various types of information such as preferred roaming networks (e.g., a list of partner networks that the home operator prioritizes based on agreements, cost efficiency, or quality of service (QoS)) and subscriber-specific preferences (e.g., information tailored to different groups of users, such as business or premium customers, that might influence which networks they are directed to).

As used herein, an “Equipment Identity Register (EIR)” may refer to a component in a communications network that helps manage and verify the identities of UEs based on their IMEISV numbers. For example, the EIR may act as a database that categorizes UEs into three lists: white list, black list, and gray list. UEs on the white list may be authorized to access the network, while black-listed devices (e.g., typically stolen, lost, or fraudulent devices) may be barred from accessing network services. Devices on the gray list may be allowed to access the network but may have restricted functionality. For example, when a UE attempts to register on the network, the EIR may cross-reference the UE's IMEISV to determine its status and decide whether it should be granted access. An EIR may store “device information,” which may refer to a set of unique identifiers, attributes, and/or status details associated with a UE. Device information may include the UE's IMEISV, which includes details about the device's current software version. Other device information stored in the EIR may include hardware specifications, device model (e.g., Type Allocation Code (TAC)), network technology capabilities, and/or compliance status with security and regulatory standards. Such device information may help operators manage device access, security, and service eligibility across their network.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions - including data structures and program modules - in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

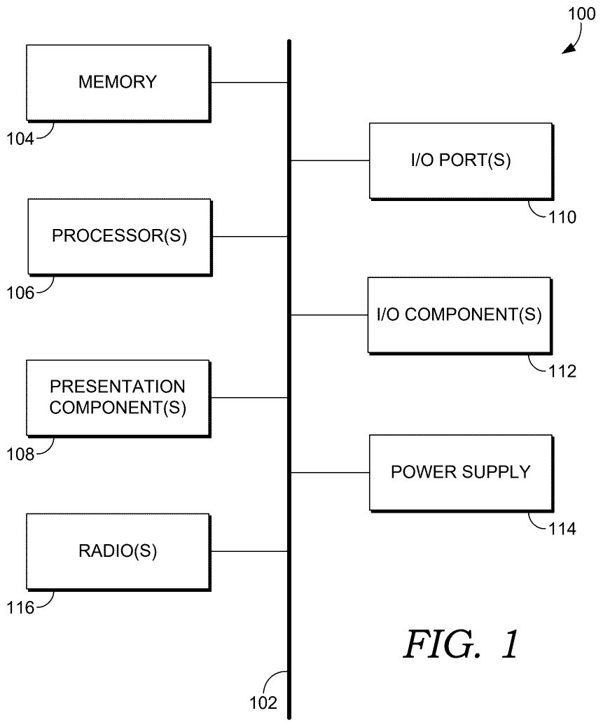

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

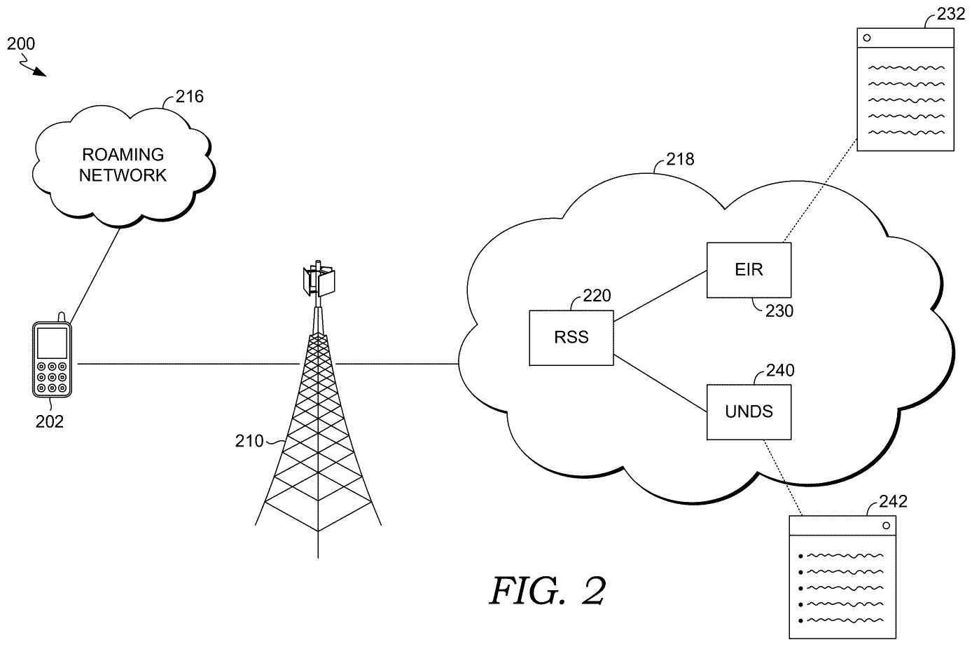

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a base station 210, a roaming network 216, a core network 218, an RSS 220, an EIR 230 that stores device information 232 of one or more UEs, and a UNDS 240 that stores RSI 242 of one or more UEs, though in some implementations, it may not be necessary for certain features to be present. The network environment may include a number of routers, switches, and the like. The network environment 200 is generally configured for wirelessly connecting the UE 202 to data or services that may be accessible through the core network 218, roaming network 216, or other functions, nodes, or servers not pictured in FIG. 2 so as to not obscure the focus on the present disclosure.

The UE 202 is illustrated generally, and may take any number of forms, including a tablet, phone, or wearable device, or any other device discussed with respect to FIG. 1 and may have any one or more components or features of the computing device 100 of FIG. 1. In some aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The base station 210 may provide a network access location where the UE may potentially connect to (also referred to as ‘camping on,’ ‘attaching,’ in the industry). Though network environment 200 is illustrated with only the base station 210, one skilled in the art will appreciate that more or fewer base stations may be present in any particular network environment. The first base station 210 is configured to wirelessly communicate with UEs, such as the UE 202. In aspects, the base station 210 may communicate with the UE 202 using any wireless telecommunication protocol desired by a network operator, including but not limited to 3G, 4G, 5G, 6G, 802.11x and the like.

The core network 218 may provide services and connectivity to the UE 202. For example, the core network 218 may manage the routing, authentication, and delivery of voice, data, and messaging services to the UE 202, regardless of whether the UE is operating within its home network or on the roaming network 216. The core network 218 may be responsible for handling key functions such as subscriber authentication, enforcing policies, and managing device access through the EIR 230. In some aspects, the core network 218 may include packet gateways and session management functions that help control the UE's 202 access to external data networks and multimedia services. For example, the core network 218 may communicate with the base station 210 to provide services to the UE 202. When the UE 202 roams, the core network 218 may help coordinate with roaming partners and manage the exchange of network preferences (e.g., RSI 242) and device information (e.g., device information 232) through systems like the RSS 220 and the UNDS 240.

When the UE 202 moves outside the coverage area of its home network, the core network 218 may help facilitate the process of identifying and attaching to an available roaming network (e.g., roaming network 216) to maintain service continuity. For example, the UE 202 may scan for available networks, and the core network 218 may play a role in guiding this process by leveraging the RSS 220 and information stored in the UNDS 240. In some cases, the RSS 220 uses the RSI 242 stored in the UNDS 240, which may contain details about preferred roaming partners and network preferences, to steer the UE 202 toward a roaming network (e.g., roaming network 216). Once the UE 202 identifies a potential roaming network, the UE 202 may send a registration request to that network, such as the roaming network 216. The roaming network 216 may communicate with the core network 218 to attempt to authenticate the UE 202 and verify its subscription and device information through components like the Home Subscriber Service (HSS) and the EIR 230. For example, the EIR 230 may help determine whether the UE 202 is authorized to access the roaming network 216 by checking the UE's 202 device information 232 to determine the UE's 202 status (e.g., white-listed, black-listed, or gray-listed).

The RSS 220, which may be implemented as a network device or a software-based component within the core network 218, may initiate a logic flow upon receiving an indication to assess compatibility or incompatibility between the UE 202 and the roaming network 216. The indication could arise from several triggers, such as the UE's 202 attempt to register with the roaming network 216, or an internal event (e.g., device registration) identifying that the UE 202 is on a gray list stored in the EIR 230, where the gray list may include a plurality of UEs operating with outdated software versions that may present challenges for specific network features, such as emergency call capabilities. Upon receiving the indication, the RSS 220 may retrieve device information 232 from the EIR 230, including the IMEISV of the UE 202, which details one or more of the hardware and software characteristics of the UE 202. The RSS 220 may also query the UNDS 240 for the RSI 242 associated with the UE 202.

After receiving the device information 232, the RSS 220 may analyze the device information 232 in conjunction with one or more features of the roaming network 216 to determine the compatibility or incompatibility between the UE 202 and the roaming network 216. The one or more network features may include support for emergency call handling, compliance with local regulatory mandates (e.g., FCC requirements for emergency calls), and technological compatibility, such as support for VoLTE or fallback mechanisms like 3G for emergency call routing. For example, the compatibility determination may hinge on whether the UE 202 can make an emergency call in the roaming network 216. In some cases, when the UE's 202 software version, as indicated by its IMESIV, may lack support for emergency protocols like VoLTE or SIP signaling, the RSS 220 may determine that the UE 202 is incompatible with the roaming network 216. Conversely, if the UE's 202 software supports emergency calling features required by the roaming network 216, the UE 202 may be determined to be compatible with the roaming network 216. Based on one of the determinations, the RSS 220 may modify the RSI 242 associated with the UE 202. For example, if the UE 202 is compatible with the roaming network 216, the RSS 220 may update the RSI 242 associated with the UE 202 to include an authorization for the UE 202 to access the roaming network 216. However, if the UE 202 is determined to be incompatible with the roaming network 216, the RSS 220 may update the RSI 242 associated with the UE 202 to impose a restriction, preventing the UE 202 from accessing the roaming network 216 or limiting its functionality to ensure compliance with regulatory requirements.

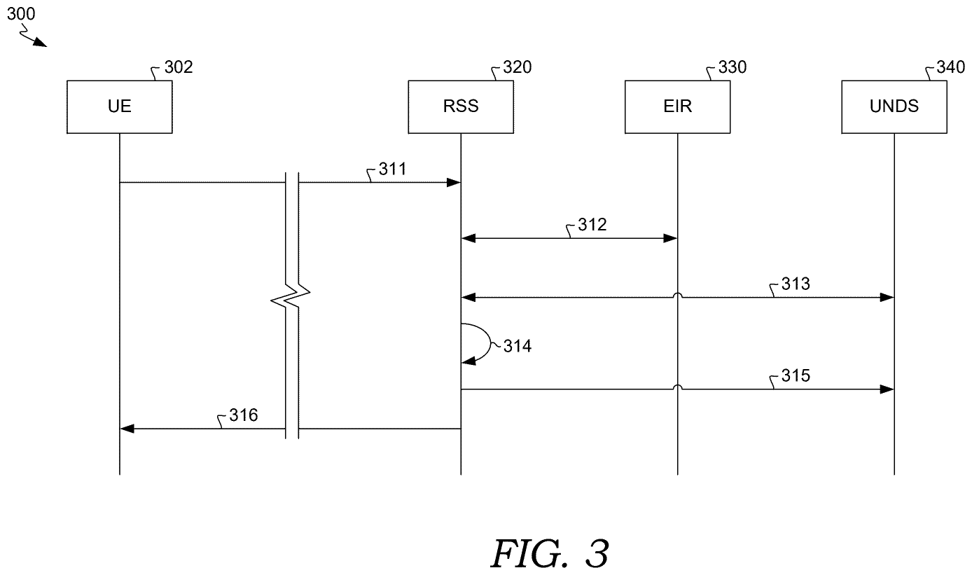

Turning now to FIG. 3, a flow diagram is illustrated in accordance with one or more aspects of the present disclosure. A flow diagram 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The flow diagram 300 may be relevantly said to include a UE 302, an RSS 320, an EIR 330, and a UNDS 340. In some aspects, the UE 302 may be the same or similar to the UE 202, the RSS 320 may be the same or similar to the RSS 220, the EIR 330 may be the same or similar to the EIR 230, and the UNDS 340 may be the same or similar to the UNDS 240 discussed above.

FIG. 3 illustrates an example method for managing network accessibility of a user equipment (UE) in a communications network. At a first step 311, the RSS 320 may receiving an indication to initiate a logic flow aimed at determining whether the UE 302 is compatible or incompatible with a roaming network. The indication may include a device registration of the UE 302 on a roaming network, for example, when the UE 302 attempts to register on the roaming network, the roaming network may send a registration request to the home network. In some cases, the indication may arise from the home network receiving a notification that the UE 302 is attempting to register on a specific roaming partner network. This notification could trigger the RSS 320 to evaluate whether the roaming network supports critical features, such as emergency calls, in line with the UE's 302 capabilities. Another indication could be the identification of the UE 302 on a gray list stored in the EIR 330, which may include a plurality of UEs operating with outdated software versions or other potential issues. For example, the identification of the UE 302 on a gray list may trigger the logic flow for the RSS 320 to assess whether the UE's 302 software might create an incompatibility with the roaming network, particularly regarding regulatory requirements like emergency call support. Additionally, the RSS 320 may also receive an indication in the form of updated roaming policies, changes to a subscriber's profile, or real-time network conditions. For example, if a subscriber has recently changed their plan to include new roaming features, the RSS 320 may assess whether the roaming network matches the updated service entitlements and emergency call support.

At a second step 312, after receiving the indication to initiate the logic flow, the RSS 320 may proceed to retrieve device information of the UE 302 from the EIR 330, where the EIR 330 may comprise a centralized database within the core network that stores details about the identity and status of UEs, particularly using the IMEISV. For example, the RSS 320 may send a query to the EIR 330 using the UE's 302 IMEI as an identifier. The query may specifically request the device information, including the IMEISV, which provides both the device's identity and its current software version. Upon receiving the query, the EIR 330 may search its database for the matching IMEI/IMEISV. The EIR 330 may retrieve additional device information such as hardware model, supported network technologies, and/or compliance status. The EIR 330 may send the request device information back to the RSS 320, which may include one or more of the IMEISV, device classification (e.g., white, black, or gray list), and any associated restrictions or warnings related to the device status of the UE 302.

At a third step 313, the RSS 320 may retrieve RSI from the UNDS 340 associated with the UE 302. The RSI may contain data that governs how the UE 302 should be steered across available roaming networks based on predefined rules, roaming agreements, and/or real-time network conditions. For example, the RSS 320 may send a query to the UNDS 340 requesting the RSI associated with the UE 302. The RSS 320 may use identifiers such as the Subscriber ID (e.g., IMSI) or other relevant subscriber information tied to the UE 302, to request the appropriate RSI profile of the UE 302. In response to the query, the UNDS 340 may search its database to locate the RSI associated with the UE's 302 subscription profile. The RSI may contain details about preferred roaming networks, excluded networks, service capabilities (e.g., information about which services are supported or restricted), and/or subscriber-specific policies. In some aspects, the RSS 320 may also request real-time data on network conditions form the UNDS 340 that includes network congestions levels, signal strength, and/or quality metrics that help in deciding whether the roaming network can provide adequate support for the UE 302. The UNDS 340 may send the requested RSI back to the RSS 320 to help the RSS 320 make an informed decision about how to handle the UE's 302 roaming behavior on the available networks, particularly whether to authorize or restrict access based on the compatibility or incompatibility with one or more features of the roaming network.

At a fourth step 314, the RSS 320 may make a determination regarding the compatibility or incompatibility between the UE 302 and the roaming network. Such a determination may be made based on the device information retrieved from the EIR 330 and one or more features of the roaming network (e.g., as retrieved through the RSI from the UNDS 340). The RSS 320 may evaluate the device information and one or more features of the roaming network to help ensure that the UE 302 can safely and effectively operate on the roaming network, with a focus on critical services such as emergency call capability. For example, the RSS 320 may analyze the device information retrieved from the EIR 330, which may include the IMEISV of the UE 302, to gain insights into the UE's 302 hardware and software configuration, including whether the UE 302 is operating with outdated software or lacks support for certain features, such as VoLTE or emergency call handling. The RSS 320 may cross-reference the device information with the one or more features of the roaming network (e.g., network technology, service support, and/or QoS) to make a compatibility determination. For example, if the UE's 302 IMEISV shows that the UE 302 has the necessary software version and capabilities (e.g., VoLTE support), and if the roaming network supports emergency calls and other essential services, the RSS 320 may determine that the UE 302 is compatible with the roaming network. Conversely, if the device information shows that the UE 302 is operating with outdated software that does not support required features (e.g., VoLTE or emergency call routing), and the roaming network lacks fallback mechanisms (e.g., 3G or 2G support for emergency calls), the RSS 320 may determine that the UE 302 is incompatible with the network.

At a fifth step 315, the RSS 320 may proceed to modify the RSI associated with the UE 302 to create a modified RSI that will dictate whether the UE 302 is authorized to connect to the roaming network or if the UE 302 is restricted from accessing the roaming network. For example, if the RSS 320 has determined that the UE 302 is compatible with the roaming network, the RSS 320 may modify the RSI associated with the UE 302 to include an authorization of the roaming network. In doing so, the RSS 320 may change the UE's 302 network preference settings in the RSI, which includes allowing the UE 302 to register with the roaming network. The modified RSI in such aspects could include modifying details such as authorized roaming networks (e.g., roaming networks identified by MCC/MNC codes that the UE 302 is permitted to connect to) and service authorizations (e.g., any associated services that the UE 302 is authorized to use while on the roaming network). This modified RSI may be sent to the UNDS 340 to update the central repository of steering information. Conversely, if the RSS 320 has determined that the UE 302 is incompatible with the roaming network, the RSS 320 may modify the RSI associated with the UE 302 to include a restriction of the roaming network. In doing so, the RSS 320 may change the UE's 302 network preference setting in the RSI, which includes restricting the UE 302 from registering with the roaming network. In some cases, the modification of the RSI may include an update that steers the UE 302 to an alternative roaming network where the device is more compatible. For example, if the UE 302 cannot connect to a 4G network due to incompatibility, the RSS 320 may modify the RSI to favor a 3G network that still supports basic services like emergency calling.

At a sixth step 316, the authorization or restriction of the UE 302 to access the roaming network based on the determination made by the RSS 320 is implemented across the communications network. This process may help ensure that the determination made by the RSS 320 is effectively applied throughout the network infrastructure. For example, in order to propagate the authorization (e.g., in addition to being stored and accessible in the UNDS 340), the RSS 320 may communicate the modified RSI to other core network elements, such as the HSS and the Policy and Charging Rules Function (PCRF). The communications network (e.g., home network) may communicate with the roaming network to signal that the UE 302 is now authorized to connect. Once the authorization is propagated, the UE 302 may be allowed to complete the registration process on the roaming network. In order to enforce the restriction, the RSS 320 may send the updated RSI to the HSS, PCRF, and/or other network elements. If network conditions change or if the UE 302 undergoes software updates that improves its compatibility, the RSS 320 may dynamically update the RSI, either lifting the restriction or modifying the authorization in order to help ensure a flexible management system that adapts to device-specific changes and network evolution.

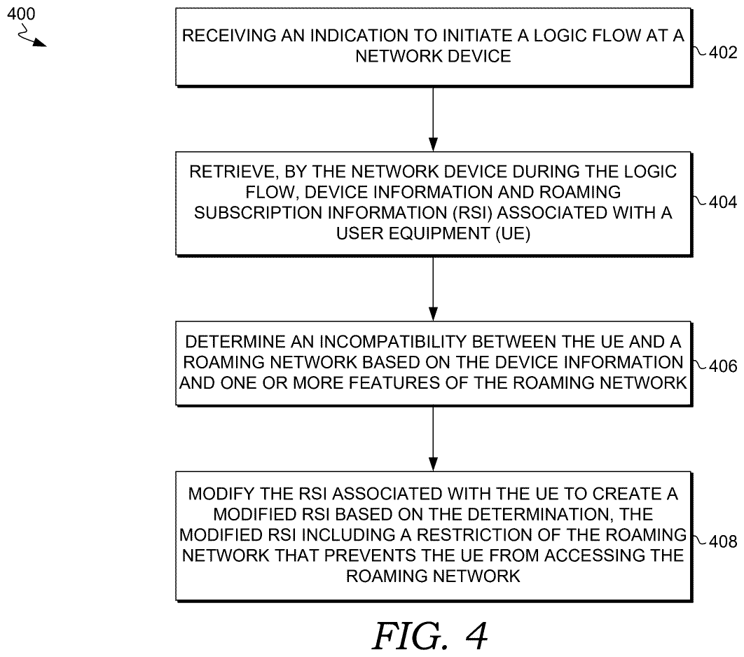

Turning now to FIG. 4, a flow chart is provided that illustrates one or more aspects of the present disclosure relating to a method 400 for managing network accessibility of a user equipment (UE) in a communications network. For example, at a first step 402, an indication is received to initiate a logic flow at a network device. At a second step 404, device information and RSI associated with the UE are retrieved by the network device during the logic flow. At a third step 406, an incompatibility between the UE and a roaming network is determined based on the device information and one or more features of the roaming network. At a fourth step 408, the RSI associated with the UE is modified based on the determination to include a restriction of the roaming network that prevents the UE from accessing the roaming network.

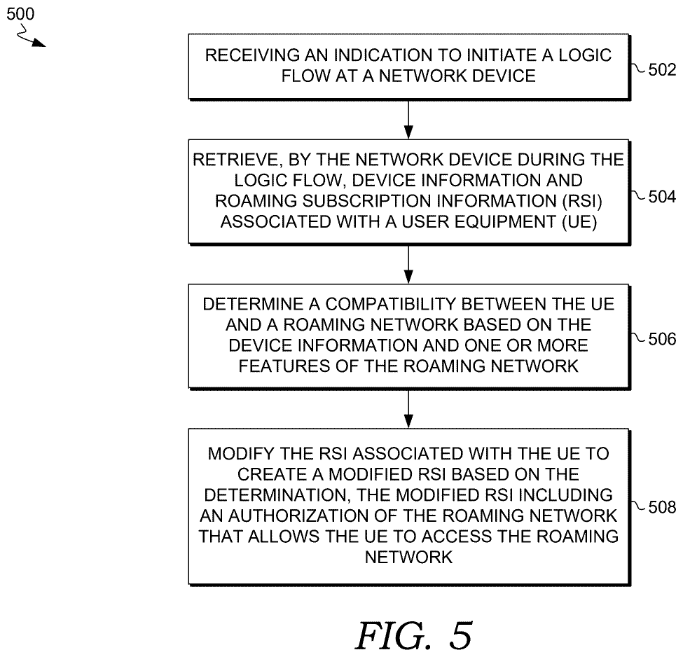

Turning now to FIG. 5, a flow chart is provided that illustrates one or more aspects of the present disclosure relating to a method 500 for managing network accessibility of a user equipment (UE) in a communications network. For example, at a first step 502, an indication is received to initiate a logic flow at a network device. At a second step 504, device information and RSI associated with the UE are retrieved by the network device during the logic flow. At a third step 506, a compatibility between the UE and a roaming network is determined based on the device information and one or more features of the roaming network. At a fourth step 608, the RSI associated with the UE is modified based on the determination to include an authorization of the roaming network that allows the UE to access the roaming network.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for managing network accessibility of a user equipment (UE) in a communications network, the system comprising:
a network device comprising one or more processors; and
a non-transitory computer-readable media comprising executable instructions that, when executed, causes the network device to perform operations in a communication network, comprising:
receiving, at the network device, an indication to initiate a logic flow;
retrieving, by the network device during the logic flow, device information and roaming subscription information (RSI) associated with the UE;
based on the device information and one or more features of a roaming network, determining an incompatibility between the UE and the roaming network; and
modifying, based on the determination, the RSI associated with the UE to create a modified RSI, wherein the modified RSI comprises a restriction of the roaming network, and wherein the restriction prevents the UE from accessing the roaming network.

2. The system of claim 1, wherein the network device comprises a roaming steering server (RSS).

3. The system of claim 1, wherein the indication comprises a device and/or network registration of the UE.

4. The system of claim 1, wherein the device information comprises an International Mobile Equipment Identity and Software Version (IMEISV) of the UE.

5. The system of claim 6 further comprising analyzing the IMEISV to determine whether the UE is capable of making an emergency call in the roaming network.

6. The system of claim 1, wherein the indication comprises identifying the UE on a gray list stored on an equipment identity register (EIR) in the communications network, the gray list comprising a plurality of UEs operating with outdated software versions.

7. The system of claim 1, wherein the RSI is retrieved from a Unified Network Directory Server (UNDS) in the communications network, and wherein the IMEISV is retrieved from an equipment identity register (EIR) in the communications network.

8. The system of claim 1, wherein the incompatibility is determined based on an inability of the UE to make an emergency call in the roaming network.

9. A system for managing network accessibility of a user equipment (UE) in a communications network, the system comprising:
a network device comprising one or more processors; and
a non-transitory computer-readable media comprising executable instructions that, when executed, causes the network device to perform operations in a communication network, comprising:
receiving, at the network device, an indication to initiate a logic flow;
retrieving, by the network device during the logic flow, device information and roaming subscription information (RSI) associated with the UE;
based on the device information and one or more features of a roaming network, determining a compatibility between the UE and the roaming network; and
modifying, based on the determination, the RSI associated with the UE to create a modified RSI, wherein the modified RSI comprises an authorization of the roaming network, and wherein the authorization allows the UE to access the roaming network.

10. The system of claim 9, wherein the network device comprises a roaming steering server (RSS).

11. The system of claim 9, wherein the indication comprises a device and/or network registration of the UE.

12. The system of claim 9, wherein the device information comprises an International Mobile Equipment Identity and Software Version (IMEISV) of the UE.

13. The system of claim 12 further comprising analyzing the IMEISV to determine whether the UE is capable of making an emergency call in one or more roaming networks.

14. The system of claim 9, wherein the indication comprises identifying the UE on a gray list stored on an equipment identity register (EIR) in the communications network, the gray list comprising a plurality of UEs operating with outdated software versions.

15. The system of claim 9, wherein the RSI is retrieved from a Unified Network Directory Server (UNDS) in the communications network, and wherein the IMEISV is retrieved from an equipment identity register (EIR) in the communications network.

16. The system of claim 9, wherein the compatibility is determined based on an ability of the UE to make an emergency call in the roaming network.

17. A method for managing network accessibility of a user equipment (UE) in a communications network, the method comprising:
receiving an indication to initiate a logic flow;
retrieving device information and roaming subscription information (RSI) associated with the UE;
based on the device information and one or more features of a roaming network, determining an incompatibility between the UE and the roaming network; and
modifying, based on the determination, the RSI associated with the UE to create a modified RSI, wherein the modified RSI comprises a restriction of the roaming network, and wherein the restriction prevents the UE from accessing the roaming network.

18. The method of claim 17, wherein the device information comprises an International Mobile Equipment Identity and Software Version (IMEISV) of the UE.

19. The method of claim 18 further comprising analyzing the IMEISV to determine whether the UE is capable of making an emergency call in one or more roaming networks.

20. The method of claim 17, wherein the incompatibility is determined based on an inability of the UE to make an emergency call in the roaming network.
